(19) United States
(12) Patent Application Publication
(10) Pub. No.: US 2026/0357725 A1
(43) Pub. Date: Nov. 12, 2026

(54) Engine Bearing Lubrication Structure

(71) Applicant: ZHEJIANG QIANJIANG MOTORCYCLE CO., LTD., Taizhou City, Zhejiang Province (CN)

(72) Inventors: Pinghui Wu, Taizhou City, Zhejiang Province (CN); Linjiang Zhang, Taizhou City, Zhejiang Province (CN); Mingming Chen, Taizhou City, Zhejiang Province (CN); Tongzhao Yang, Taizhou City, Zhejiang Province (CN); Lin Zheng

(73) Assignee: Zhejiang Qianjiang Motorcycle Co., Ltd., Taizhou City, Zhejiang Province (CN)

(21) Appl. No.: 18/996,985

(22) PCT Filed: Jul. 4, 2023
(86) PCT No.: PCT/CN2023/105621

§ 371 Date: Jan. 18, 2025

(30) Foreign Application Priority Data
Aug. 2, 2022 (CN) 202210921780.8

(51) Int. Cl. F01M 11/02; F01M 9/06; F01M 9/10; F01M 11/00

(52) U.S. Cl. CPC F01M 11/02; F01M 9/06; F01M 9/10; F01M 11/0004; F01M 2011/0095; F01M 2011/021

(57) ABSTRACT

The present disclosure provides an engine bearing lubrication structure. An engine includes a tank, a wall of the tank is provided with a bearing hole seat for mounting a bearing and the lubrication structure includes an oil storage chamber and an oil guiding hole which are located in the wall of the tank, the oil storage chamber is provided with an opening for allowing oil droplets to enter, a bottom of the opening in a vertical direction is blocked by an oil baffle block, a first end of the oil guiding hole communicates with the oil storage chamber, and a second end of the oil guiding hole communicates with a bearing chamber enclosed by the bearing hole seat.

### TECHNICAL FIELD

The present disclosure belongs to the technical field of bearing lubrication, and relates to an engine bearing lubrication structure.

### BACKGROUND

Bearing lubrication methods include both forced lubrication and non-forced lubrication, the forced lubrication method requires an oil passage to be disposed in a tank, engine oil enters the oil passage in the tank through an oil pump, and engine oil in the oil passage then enters a bearing mounting hole of the tank to lubricate a bearing, and the unforced lubrication method utilizes engine oil splashed and accumulated on an inner wall of the tank flowing into the bearing to lubricate the bearing.

For the existing bearing non-forced lubrication structure, for example, Chinese patent document discloses a lubrication structure for bearings at an end of an engine gear shaft [Application No.: CN200710093001.5; publication No.: CN101158300A], an inner end of an outer ring of a bearing for mounting a gear shaft is provided with a radial oil groove, a bearing hole seat for mounting a bearing in an inner wall of a tank of an engine is provided with a radial groove communicating with the radial oil groove in the bearing, the inner wall of the tank of the engine is provided with two reinforcing ribs, a wall cavity where splashed oil droplets are accumulated is enclosed by the reinforcing ribs and the bearing hole seat, and the radial groove in the bearing hole seat communicates with a lowermost portion of the wall cavity.

In the lubrication structure described above, the radial oil groove needs to be formed at the inner end of the outer ring of the bearing, i.e., the structure of the bearing needs to be changed; meanwhile, in the lubrication structure described above, the radial groove is located in an inner end face of the bearing hole seat, when oil in the wall cavity passes through the radial groove, the oil will directly flow back to the oil storage position of the tank through a groove opening of the radial groove, there is a problem of leakage of the oil in the wall cavity, and the oil in the wall cavity directly flowing back does not lubricate the bearings. The amount of the oil in the wall cavity flowing to the bearings becomes small, so that the bearings are not lubricated with sufficient lubricating oil, resulting in poor lubrication effects of the bearings.

### SUMMARY

For the above problems in the prior art, an object of the present disclosure is to propose an engine bearing lubrication structure, and the technical problem of how to improve the lubricating effect of bearings is solved.

The object of the present disclosure can be achieved by the following technical solutions: provided is an engine bearing lubrication structure, an engine including a tank, a wall of the tank is provided with a bearing hole seat for mounting a bearing, wherein the lubrication structure includes an oil storage chamber and an oil guiding hole which are located in the wall of the tank, the oil storage chamber is provided with an opening for allowing oil droplets to enter, a bottom of the opening in a vertical direction is blocked by an oil baffle block, one end of the oil guiding hole communicates with the oil storage chamber, and the other end of the oil guiding hole communicates with a bearing chamber enclosed by the bearing hole seat.

Oil droplets splashed inside the tank enter the oil storage chamber through the opening, the oil baffle block blocks the bottom of the opening of the oil storage chamber so that the oil droplets entering the oil storage chamber do not leak out, it is ensured that all the oil droplets entering the oil storage chamber flow to the bearing chamber through the oil guiding hole, it is ensured that there is sufficient lubricating oil to lubricate bearings, and the lubricating effect of the bearings is improved so that the bearings are not damaged. The oil baffle block is independently arranged to facilitate the removal of a mold during the manufacture of the tank, and the lubrication structure is simple without the need to specifically provide a lubricating oil passage for bearings.

In the engine bearing lubrication structure as described above, a rotatable bevel gear is disposed in the tank, the bevel gear is located directly below the opening of the oil storage chamber in the vertical direction, a center line of the bevel gear is perpendicular to an orientation of the opening of the oil storage chamber, and the oil droplets rotated and swung by the bevel gear are capable of entering the oil storage chamber through the opening. The rotation of the bevel gear will drive lubricating oil. Under the action of a centrifugal force, the bevel gear can throw the lubricating oil out along a tangential direction to form oil droplets. The oil droplets can be thrown into the oil storage chamber through the opening, and the oil droplets in the oil storage chamber flow to the bearing chamber through the oil guiding hole to ensure the lubrication effect of the bearings.

In the engine bearing lubrication structure as described above, the oil baffle block includes an embedded portion and an oil blocking portion which are integrally disposed, a top of the oil blocking portion is located above the embedded portion in the vertical direction, the embedded portion is embedded into and sealingly fixed to a bottom of the oil storage chamber, and the oil blocking portion is sealingly adhered to a chamber wall of the oil storage chamber at the bottom of the opening in the vertical direction. In this structure, the sealing area of the oil baffle block is increased to ensure that the oil droplets entering the oil storage chamber do not leak out, the top of the oil blocking portion is located above the embedded portion in the vertical direction, ensuring that the oil baffle block can block the oil droplets in the oil storage chamber, so that the oil droplets entering the oil storage chamber can only enter the bearing chamber through the oil guiding hole, and the lubricating effect of the bearings is improved.

In the engine bearing lubrication structure as described above, the opening is disposed along an outer edge of the bearing hole seat, and a length L1 of the oil blocking portion in a length direction of the opening is ¼-½ of a length L0 of the opening. This structure makes the oil storage chamber be closer to the bearings, so that the lubrication structure is compact, a space occupied by the lubrication structure is reduced, and the oil blocking portion can block the oil droplets in the oil storage chamber from leaking out without preventing the oil droplets from entering the oil storage chamber.

In the engine bearing lubrication structure as described above, a chamber wall of the oil storage chamber is provided with a protruding limit block, the oil blocking portion abuts against the limit block, and the embedded portion is located below the limit block in the vertical direction. The setting of the limit block plays a blocking role, preventing the oil baffle block from being recessed into the oil storage chamber without blocking the bottom of the opening, the oil baffle block is installed in place, ensuring that the oil blocking portion of the oil baffle block is located at the bottom of the opening for oil blocking, so that the oil droplets in the oil storage chamber do not leak out and the lubrication effect of the bearings is improved.

In the engine bearing lubrication structure as described above, the tank includes a first housing and a second housing, the oil storage chamber is located in the first housing, an edge, close to the first housing, of the second housing is provided with a protruding compression block, and the compression block is compressed against the oil baffle block when the first housing is adhered to and fixedly connected to the second housing by a fastener. The compression block plays a compression function to prevent the oil baffle block from falling out of the oil storage chamber, and the oil baffle block is installed in place, so that the oil droplets in the oil storage chamber do not leak out and the lubrication effect of the bearings is improved.

In the engine bearing lubrication structure as described above, the bearing chamber is provided with a concavely arranged transition cavity at a middle of a chamber bottom for allowing the bearing to abut against, and the oil guiding hole communicates with the transition cavity. In this structure, the oil droplets in the oil storage chamber enter the transition cavity through the oil guiding hole, and the transition cavity also has the function of storing lubricating oil, and the setting of the transition cavity makes all the oil droplets need to pass through the bearing to return to the oil storage position of the tank, so that all the oil droplets in the oil storage chamber play a lubricating role on the bearing and the lubricating effect of the lubricating structure is improved.

In the engine bearing lubrication structure as described above, a cross section of the transition cavity in a radial direction of the bearing hole seat is circular, and an inner diameter of the transition cavity is less than or equal to an inner diameter of an inner ring of the bearing. The setting of the transition cavity will not reduce the axial abutting area of the bearing and will not reduce the stability of the bearing.

In the engine bearing lubrication structure as described above, the lubrication structure further includes a wall cavity concavely disposed in the tank and a plurality of oil passage grooves concavely disposed in an outer end surface of the bearing hole seat, the wall cavity being arranged around the outer edge of the bearing hole seat, both ends of the oil passage grooves respectively penetrating through an inner circumferential surface and an outer circumferential surface of the bearing hole seat. The outer end surface of the bearing hole seat refers to an end surface, facing the same direction as the opening, of the bearing hole seat; and the outer edge of the bearing hole seat refers to an outer edge at the outer end surface of the bearing hole seat. When the thrown oil droplets are located at the outer edge of the bearing hole seat, they can enter the bearing chamber through the wall cavity and the oil passage grooves, and the wall cavity and the oil passage grooves play a further lubricating role, so that the oil droplets located at the outer edge of the bearing hole seat flow to the bearing as much as possible, and the lubricating effect of the bearing is improved.

In the engine bearing lubrication structure as described above, the lubrication structure further includes an oil injection hole penetrating in the tank, an inner end of the oil injection hole communicating with the oil storage chamber, an outer end of the oil injection hole penetrating through the tank, the outer end of the oil injection hole being detachably plugged by a plug, and a central axis of the oil injection hole coinciding with a central axis of the oil guiding hole. If necessary, lubricating oil can be injected inward through the oil injection hole to ensure that there is enough lubricating oil in the oil storage chamber and the transition cavity to ensure the lubricating effect of the bearing; and at the same time, the setting of the oil injection hole makes the machining of the oil guiding hole convenient.

Compared with the prior art, the engine bearing lubrication structure provided by the present disclosure has the following advantages:
1. The lubrication structure ensures that the oil droplets thrown into the oil storage chamber are not leaked by setting the oil baffle block, ensuring that sufficient oil droplets flow to the bearing chamber through the oil guiding hole to lubricate the bearing, thereby improving the lubricating effect of the bearing, so that the bearing is not damaged.
2. The oil baffle block of the lubrication structure is provided to facilitate the removal of the mold during the machining of the tank, and at the same time, the lubrication structure is simple without the need to specifically provide a lubricating oil passage for bearings. In addition, there is no need to form oil holes in the bearing to ensure structural integrity of the bearing.

### BRIEF DESCRIPTION OF THE DRAWINGS

FIG. 1 is a view showing a state of use of an engine bearing lubrication structure.

FIG. 2 is a schematic diagram of an overall structure of the bearing lubrication structure.

FIG. 3 is a schematic diagram of an overall structure of the bearing lubrication structure without an oil baffle block.

FIG. 4 is a schematic diagram of an overall structure of the oil baffle block of the bearing lubrication structure.

FIG. 5 is an exploded view of an engine tank.

FIG. 6 is a front view of FIG. 1 with an expanded display range.

FIG. 7 is a cross-sectional view taken along a direction A-A of FIG. 6.

FIG. 8 is a partial cross-sectional view taken along a direction B-B in FIG. 6.

FIG. 9 is a front view of FIG. 2.

In the drawings, 1, tank; 101, first housing; 102, second housing; 2, bearing; 3, bearing hole seat; 31, bearing chamber; 4, oil storage chamber; 41, opening; 5, oil guiding hole; 6, oil baffle block; 61, embedded portion; 62, oil blocking portion; 7, limit block; 8, compression block; 9, transition cavity; 10, wall cavity; 11, oil passage groove; 12, oil injection hole; 13, plug; and 14, bevel gear.

### DETAILED DESCRIPTION

The following are specific embodiments of the present disclosure and the technical solutions of the present disclosure are further described with reference to the accompanying drawings, but the present disclosure is not limited to these embodiments.

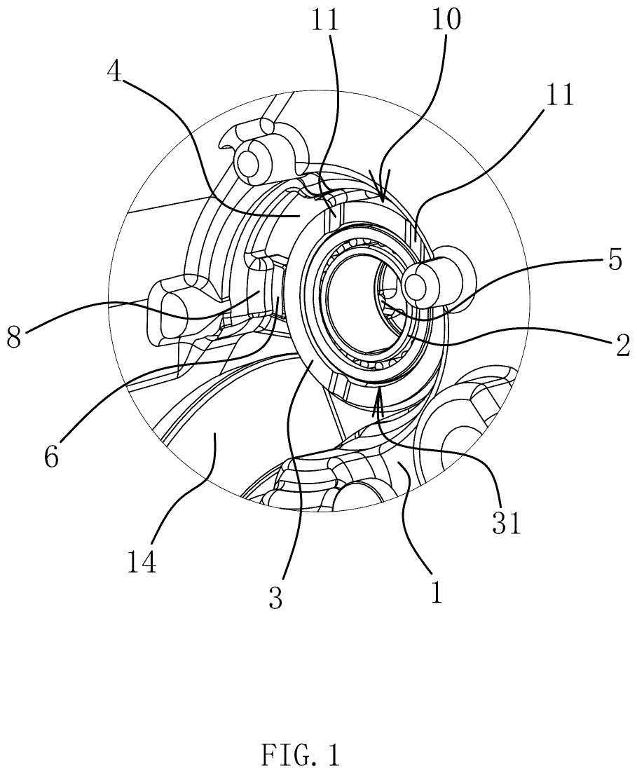

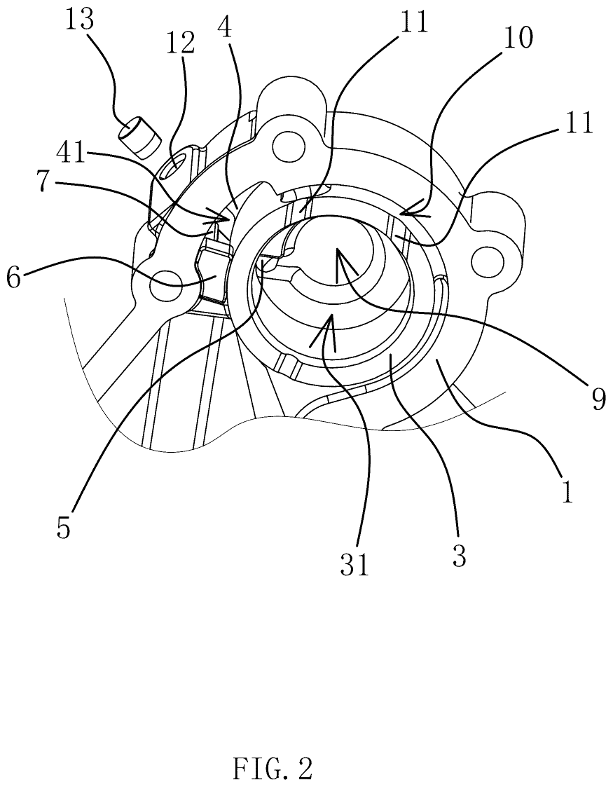

As shown in FIGS. 1 and 2, an engine includes a tank 1, a wall of the tank 1 is provided with a bearing hole seat 3 for mounting a bearing 2, and a lubrication structure includes an oil storage chamber 4 and an oil guiding hole 5 which are located in the wall of the tank 1, a wall cavity 10 concavely disposed in the tank 1, oil passage grooves 11 concavely disposed in an outer end surface of the bearing hole seat 3, and an oil injection hole 12 penetrating in the tank 1.

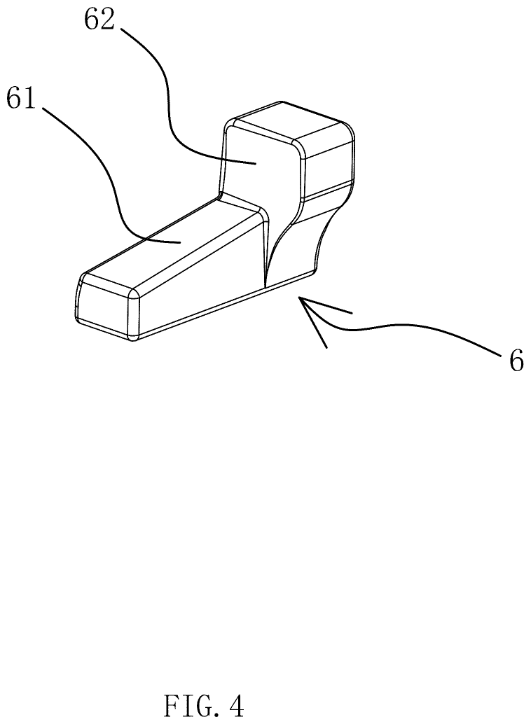

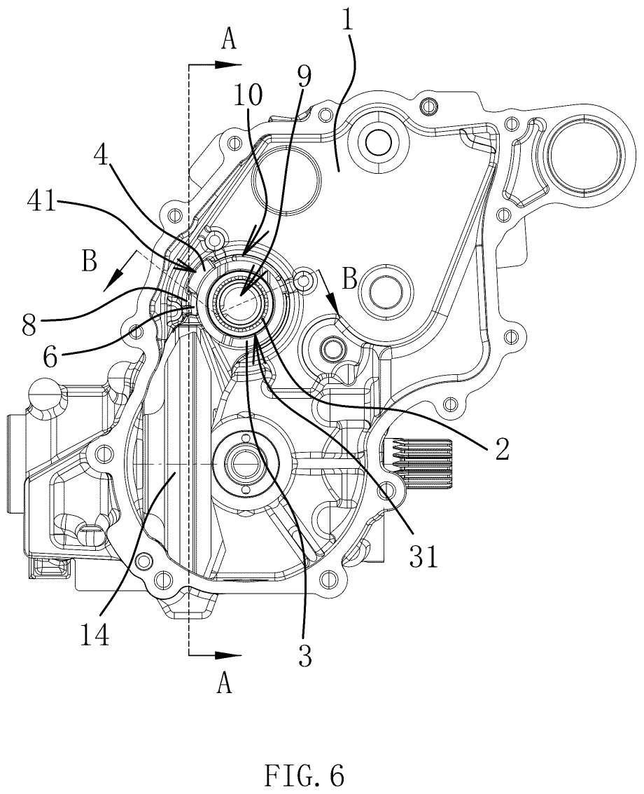

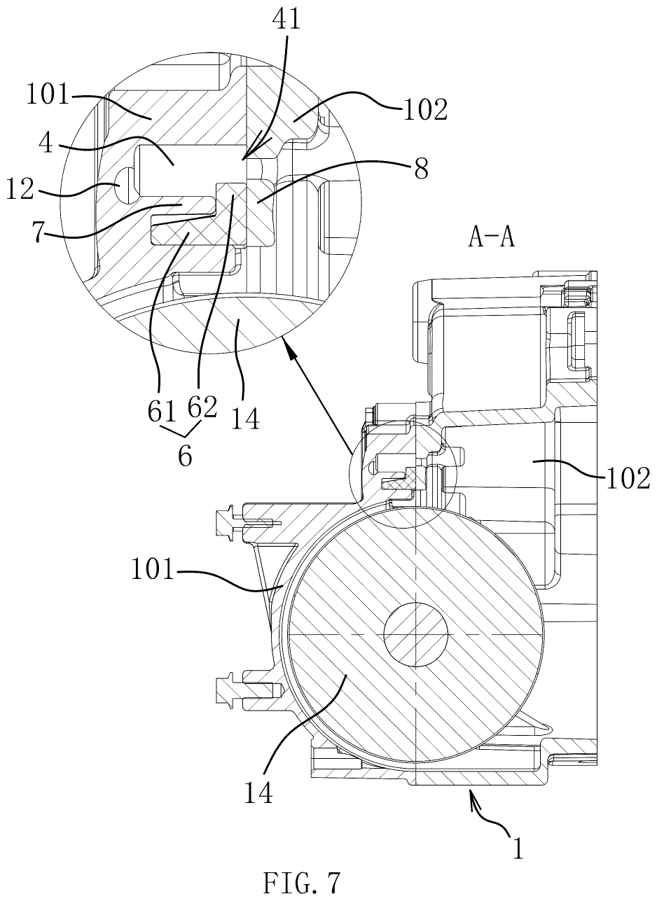

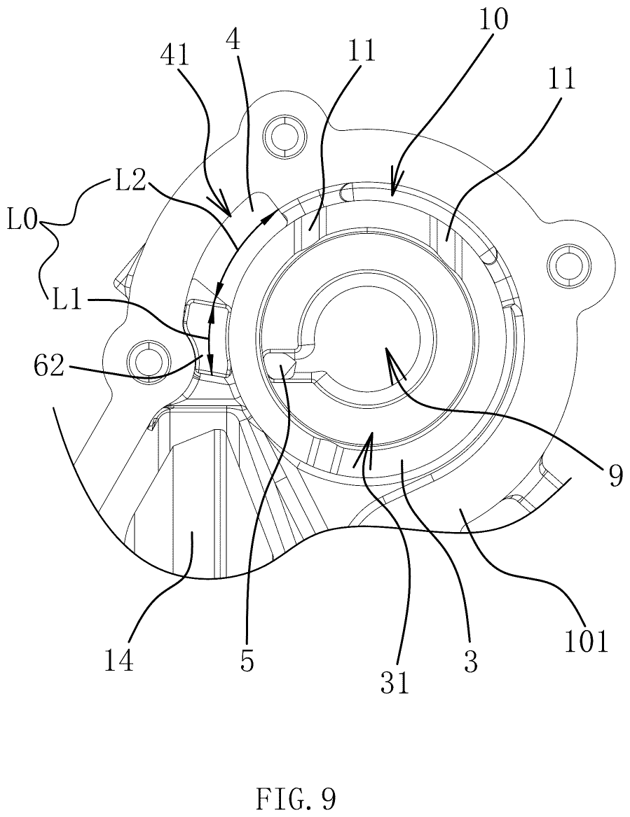

As shown in FIGS. 1, 6, 7 and 8, a rotatable bevel gear 14 s disposed in the tank 1, the bevel gear 14 is located directly below an opening 41 of the oil storage chamber 4 in a vertical direction, the oil storage chamber 4 is provided with the opening 41 for allowing splashed oil droplets to enter, a center line of the bevel gear 14 is perpendicular to an orientation of the opening 41 of the oil storage chamber 4, and oil droplets rotated and swung by the bevel gear 14 are capable of entering the oil storage chamber 4 through the opening 41. One end of the oil guiding hole 5 communicates with a bottom of the oil storage chamber 4, and the other end of the oil guiding hole 5 communicates with a bearing chamber 31 enclosed by the bearing hole seat 3. The opening 41 of the oil storage chamber 4 is disposed along an outer edge of the bearing hole seat 3, and a bottom of the opening 41 in the vertical direction is blocked by an oil baffle block 6. Specifically, as shown in FIGS. 4, 7 and 8, the oil baffle block 6 includes an embedded portion 61 and an oil blocking portion 62 which are integrally disposed, a top of the oil blocking portion 62 is located above the embedded portion 61 in the vertical direction, the embedded portion 61 is embedded into and sealingly fixed to the oil storage chamber 4, and the oil blocking portion 62 is sealingly adhered to a chamber wall of the oil storage chamber 4 at the bottom of the opening 41 in the vertical direction. In this embodiment, as shown in FIG. 9, a length of the oil blocking portion 62 in a length direction of the opening 41 is L1, a length of a portion at the opening 41 which is not blocked by the oil blocking portion 62 in the length direction of the opening 41 is L2, and a length of the opening 41 is L0, and L0=L1+L2, wherein the length L1 of the oil blocking portion 62 in the length direction of the opening 41 is ⅓ of the length L0 of the opening 41. In actual production, the length L1 of the oil blocking portion 62 in the length direction of the opening 41 may also be ¼ or ½ of the length L0 of the opening 41.

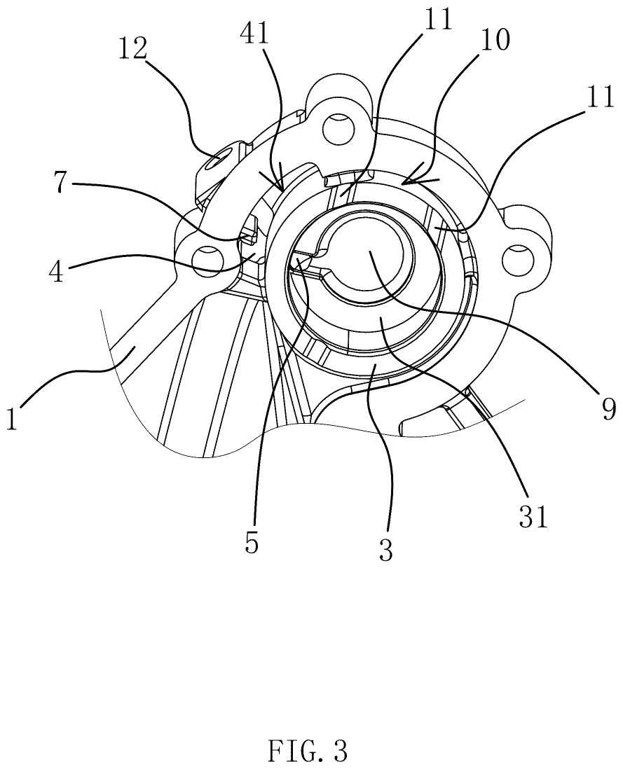

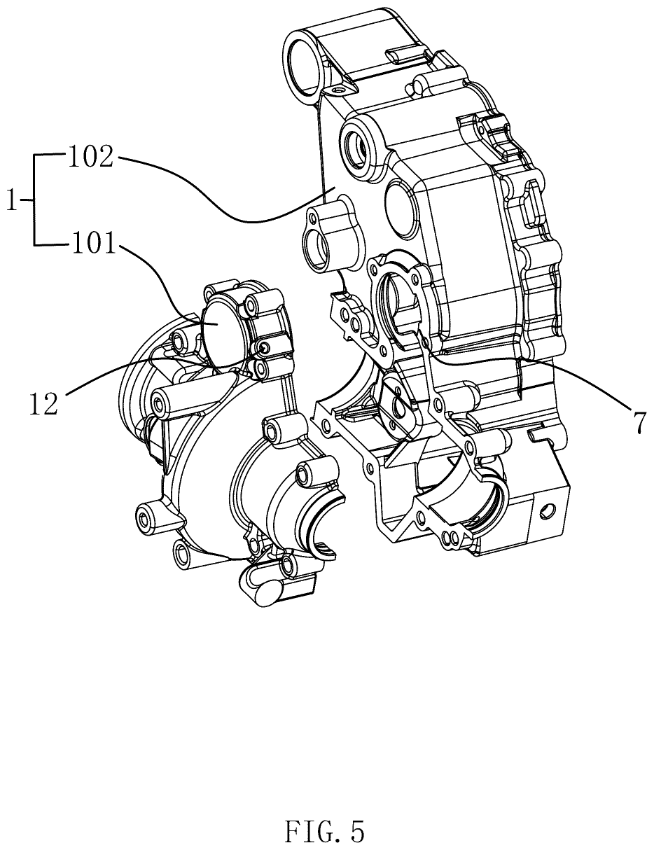

As shown in FIGS. 2, 3, 7 and 8, a chamber wall of the oil storage chamber 4 is provided with a protruding limit block 7, the oil blocking portion 62 abuts against the limit block 7, and the embedded portion 61 is located below the limit block 7 in the vertical direction. As shown in FIGS. 5, 7, 8 and 9, the tank 1 includes a first housing 101 and a second housing 102, the oil storage chamber 4 is located in the first housing 101, an edge, close to the first housing 101, of the second housing 102 is provided with a protruding compression block 8, and the compression block 8 is compressed against the oil baffle block 6 when the first housing 101 is adhered to and fixedly connected to the second housing 102 by a fastener such as bolts.

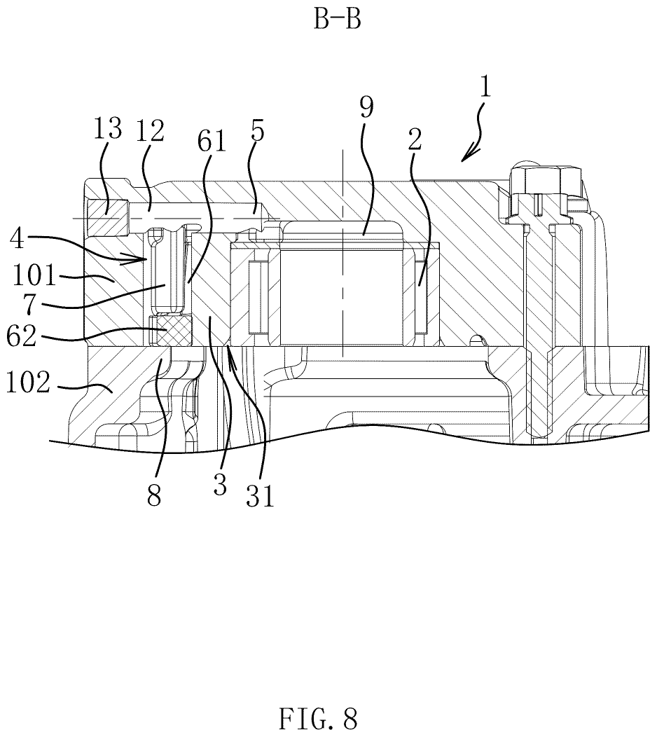

As shown in FIGS. 1, 2, 3 and 9, the wall cavity 10 is arranged around the outer edge of the bearing hole seat 3, and both ends of the oil passage grooves 11 respectively penetrate an inner circumferential surface and an outer circumferential surface of the bearing hole seat 3. As shown in FIG. 8, an inner end of the oil injection hole 12 communicates with the oil storage chamber 4, an outer end of the oil injection hole 12 penetrates through the tank 1, and the outer end of the oil injection hole 12 is detachably plugged by a plug 13 which is generally in threaded connection in the oil injection hole 12. A central axis of the oil injection hole 12 coincides with a central axis of the oil guiding hole 5. As shown in FIGS. 2 and 8, the bearing chamber 31 is provided with a concavely arranged transition cavity 9 at a middle of a chamber bottom for allowing the bearing 2 to abut against, and the oil guiding hole 5 communicates with the transition cavity 9. A cross section of the transition cavity 9 in a radial direction of the bearing hole seat 3 is circular. In this embodiment, an inner diameter of the transition cavity 9 is equal to an inner diameter of an inner ring of the bearing 2. In actual production, the inner diameter of the transition cavity 9 may also be less than the inner diameter of the inner ring of the bearing 2.

Lubricating oil is stored at the bottom of an inner cavity of the tank 1, and a bottom side of the bevel gear 14 is soaked in the lubricating oil. In operation, the bevel gear 14 rotates to drive the lubricating oil and swing the lubricating oil into oil droplets. Part of the oil droplets enter the oil storage chamber 4 through the opening 41 and then flow partly to the bearing chamber 31 through the oil guiding hole 5 and flow partly to the transition cavity 9 and then flow to the bearing chamber 31 to lubricate the bearing 2 from inside to outside. Simultaneously with the above process, part of the lubricating oil flows into the wall cavity 10 and then enters the bearing chamber 31 through the oil passage grooves 11 to lubricate the bearing 2 from outside to inside. The lubricating oil eventually also flows to the inside of the tank 1 to form a circulation.

The specific embodiments described herein are merely illustrative of the spirit of the present disclosure. Those skilled in the art to which the present disclosure belongs may make various modifications or supplements or similar substitutions to the specific embodiments described without departing from the spirit of the present disclosure or being beyond the scope defined by the appended claims.

Although the terms such as tank 1, first housing 101, second housing 102, bearing 2, bearing hole seat 3, bearing chamber 31, oil storage chamber 4, opening 41, oil guiding hole 5, oil baffle block 6, embedded portion 61, oil blocking portion 62, limit block 7, compression block 8, transition cavity 9, wall cavity 10, oil passage groove 11, oil injection hole 12, plug 13, and bevel gear 14 are used extensively, the possibility of using other terms is not excluded. These terms are used merely to more conveniently describe and explain the essence of the present disclosure; and the terms are to be construed as any additional limitation, which would depart from the spirit of the present disclosure.

1. An engine bearing lubrication structure, an engine comprising a tank, a wall of the tank being provided with a bearing hole seat for mounting a bearing, wherein the lubrication structure comprises an oil storage chamber and an oil guiding hole which are located in the wall of the tank, the oil storage chamber is provided with an opening for allowing oil droplets to enter, a bottom of the opening in a vertical direction is blocked by an oil baffle block, a first end of the oil guiding hole communicates with the oil storage chamber, and a second end of the oil guiding hole communicates with a bearing chamber enclosed by the bearing hole seat.

2. The engine bearing lubrication structure as claimed in claim 1, wherein a rotatable bevel gear is disposed in the tank, the bevel gear is located directly below the opening of the oil storage chamber in the vertical direction, a center line of the bevel gear is perpendicular to an orientation of the opening of the oil storage chamber, and the oil droplets rotated and swung by the bevel gear are capable of entering the oil storage chamber through the opening.

3. The engine bearing lubrication structure as claimed in claim wherein the oil baffle block comprises an embedded portion and an oil blocking portion which are integrally disposed, a top of the oil blocking portion is located above the embedded portion in the vertical direction, the embedded portion is embedded into and sealingly fixed to a bottom of the oil storage chamber and the oil blocking portion is sealingly adhered to a chamber wall of the oil storage chamber at the bottom of the opening in the vertical direction.

4. The engine bearing lubrication structure as claimed in claim 3, wherein the opening is disposed along an outer edge of the bearing hole seat, and a length L1 of the oil blocking portion in a length direction of the opening is ¼-½ of a length L0 of the opening

5. The engine bearing lubrication structure as claimed in claim 3, wherein a chamber wall of the oil storage chamber is provided with a protruding limit block, the oil blocking portion abuts against the limit block, and the embedded portion is located below the limit block in the vertical direction.

6. The engine bearing lubrication structure as claimed in claim 1, or wherein the tank comprises a first housing and a second housing the oil storage chamber is located in the first housing an edge, close to the first housing, of the second housing is provided with a protruding compression block, and the compression block is compressed against the oil baffle block when the first housing is adhered to and fixedly connected to the second housing by a fastener.

7. The engine bearing lubrication structure as claimed in claim 1, or wherein the bearing chamber is provided with a concavely arranged transition cavity at a middle of a chamber bottom for allowing the bearing to abut against, and the oil guiding hole communicates with the transition cavity

8. The engine bearing lubrication structure as claimed in claim 7, wherein a cross section of the transition cavity in a radial direction of the bearing hole seat is circular, and an inner diameter of the transition cavity is less than or equal to an inner diameter of an inner ring of the bearing.

9. The engine bearing lubrication structure as claimed in claim 1, wherein the lubrication structure further comprises a wall cavity concavely disposed in the tank and a plurality of oil passage grooves concavely disposed in an outer end surface of the bearing hole seat, the wall cavity being arranged around the outer edge of the bearing hole seat, both ends of the oil passage grooves respectively penetrating through an inner circumferential surface and an outer circumferential surface of the bearing hole seat.

10. The engine bearing lubrication structure as claimed in claim wherein the lubrication structure further comprises an oil injection hole penetrating in the tank, an inner end of the oil injection hole communicating with the oil storage chamber, an outer end of the oil injection hole penetrating through the tank, the outer end of the oil injection hole being detachably plugged by a plug a central axis of the oil injection hole coinciding with a central axis of the oil guiding hole.
